(19) United States
(12) Patent Application Publication
(10) Pub. No.: US 2023/0145925 A1
(43) Pub. Date: May 11, 2023

(54) Method and Control Unit for Controlling a Camera

(71) Applicant: Bayerische Motoren Werke Aktiengesellschaft, Muenchen (DE)

(72) Inventors: Claudia LIEBAU, Landshut (DE); Daniel LIEBAU, Landshut (DE)

(21) Appl. No.: 17/802,501

(22) PCT Filed: Dec. 10, 2020
(86) PCT No.: PCT/EP2020/085485

§ 371 Date: Aug. 25, 2022

(30) Foreign Application Priority Data
Mar. 25, 2020 (DE) 10 2020 108 130.8

(51) Int. Cl. H04N 23/60; G06T 7/70; G08G 1/0969; B60C 11/24; B60C 23/04

(52) U.S. Cl. CPC H04N 23/64; G06T 7/70; G08G 1/0969; B60C 11/24; B60C 23/04; G06T 2207/30252

(57) ABSTRACT

A control unit determines subject data in relation to a subject, and controls a vehicle camera in accordance with the subject data so as to capture an image of the subject using the camera.

### BACKGROUND AND SUMMARY OF THE INVENTION

The invention relates to the control of a camera in a vehicle.

It is often the case (e.g. on a vacation trip) that an occupant of a vehicle would like to take photographs of the surroundings of the vehicle with a camera while the vehicle is travelling. The movement of the vehicle typically makes it difficult for the vehicle occupant to judge the correct time to trigger the camera shutter. As a result, the quality of the photos taken in a vehicle is often relatively poor.

This document deals with the technical problem of reliably and efficiently increasing the quality of the images or photos taken with a camera while driving in a vehicle.

The object of the invention is achieved by each of the independent claims. Advantageous embodiments are specified in the dependent claims, among others. It should be noted that additional features of a patent claim that is dependent on an independent claim, without the features of the independent claim or only in combination with a subset of the features of the independent claim, may constitute a separate invention which is independent of the combination of all the features of the independent patent claim and which may become the subject matter of an independent claim, a divisional application, or a subsequent application. This applies equally to technical teachings described in the description, which may constitute an invention independently of the features of the independent claims.

According to one aspect, a control unit is described for controlling a camera (e.g. a (digital) camera that can be held in the hand by a user, such as a single lens reflex camera or a compact camera) that is carried in a (motor) vehicle. For example, the camera can be held by the user. Alternatively, the camera may be mounted on a bracket on the vehicle (inside the vehicle). The control unit can be at least partially (or completely) part of the camera. Alternatively or additionally, the control unit may be at least partially (or completely) part of the vehicle. The control unit can be configured to communicate with the camera via a wireless or wired communication link (in particular, to enable the control unit to control the camera).

The control unit is configured to determine subject data in relation to a subject to be captured. The subject may be arranged in front of, next to or behind the vehicle in the direction of travel. The subject data can indicate the shutter release time and/or the shutter release position at which the camera is to be triggered in order to take the photograph of the subject.

The subject data can be sent from a vehicle-external unit (outside the vehicle) and received by the control unit (e.g. via a wireless communication link). In particular, the control unit can be configured to send a request to a vehicle-external unit to provide subject data for the subject (e.g. based on user input at a user interface). In addition, the control unit can be configured to receive the subject data from the vehicle-external unit in response to the request.

The subject data can be received from another road user (e.g. from a vehicle traveling up ahead), which is positioned in front of the vehicle in the vehicle's direction of travel. Alternatively or in addition, the subject data can be received from an infrastructure unit (e.g. on a bridge) of the road network on which the vehicle is currently driving. The data can be received via vehicle-to-vehicle communication.

The control unit is also configured to control the camera in accordance with the subject data (in particular automatically) in order to take a photograph of the subject using the camera.

This means that subject data can be provided (in particular by a vehicle-external unit) that allows the user of the camera to control the camera (in particular automatically) in order to take a high-quality photograph of a subject.

The subject data can indicate how the vehicle should move for taking the photograph of the subject. In particular, the subject data can indicate: the traffic lane in which the vehicle should be located in order to take the photograph; the speed at which the vehicle should drive in order to take the photograph; the trajectory along which the vehicle should drive in order to take the photograph; and/or the orientation that the vehicle should take up relative to the subject to take the photograph.

The control unit can be configured to cause the vehicle to move as indicated by the subject data. In particular, the control unit can be configured to send an instruction to a driver of the vehicle to cause the vehicle to move as indicated by the subject data. Alternatively or in addition, the control unit can be configured to intervene automatically in the longitudinal and/or lateral guidance of the vehicle in order to cause the vehicle to move as indicated by the subject data.

The control unit can thus be configured to reach a target state of the vehicle at a specific time for taking the photograph based on an actual state of the vehicle. For this purpose, for example, a longitudinal deceleration (braking) and/or lateral movement (steering) of the vehicle can be effected in order to reach the target state of the vehicle at the shutter release time and/or at the shutter release position. By influencing the movement of the vehicle for taking the photo, the quality of the photograph taken can be further enhanced.

The control unit can be configured to determine position data (e.g. GPS coordinates) in relation to the position of the vehicle. The camera can then also be controlled in accordance with the position data, in particular taking into account a digital map relating to the road network on which the vehicle is driving, in order to take the photograph of the subject using the camera. This allows the quality of the photograph taken to be increased further.

The control unit can be configured to determine vehicle data in relation to the state of the vehicle. The vehicle data can comprise: information relating to the tire pressure of at least one of the tires on the vehicle; information relating to the tire wear of the vehicle; information relating to a loading condition of the vehicle; and/or information relating to the vehicle speed. The camera can then also be controlled in accordance with the vehicle data in order to take the photograph of the subject using the camera. This allows the quality of the photograph taken to be increased further.

The control unit may be configured to collect environment data relating to the environment of the vehicle (in particular in relation to the subject in the environment of the vehicle). The environment data may have been recorded by one or more environment sensors (e.g. an environment camera, a radar sensor, a lidar sensor, etc.) of the vehicle. The subject data can then be determined in a precise manner (if applicable, also) on the basis of the environment data. Alternatively or additionally, the user's camera can then (if applicable, also) be controlled in accordance with the environment data in order to take the photograph of the subject using the camera. This allows the quality of the photograph taken to be increased further.

The control unit can have access to a list of one or more pre-selected subject types, with the list showing which subject types the user is interested in photographing. Example subject types are: point of interest, sunsets, viewpoints, plants, animals, etc. The control unit can be configured to determine whether a subject of the preselected subject type is present on the route taken by the vehicle. This can be determined, for example, by a request to a vehicle-external unit (e.g. by a request to a vehicle in front or to an infrastructure unit). When a subject of the preselected subject type is detected, subject data for the detected subject can be determined in order to control the camera so that the camera can take a photograph of the subject. This further increases the convenience for the user.

The subject may be, e.g., a background image for a self-portrait of the user. The camera can then be controlled to take a self-portrait of the user (i.e. a so-called “selfie”) with the subject to be captured in the background, based on the subject data.

According to another aspect a (road) motor vehicle (in particular a passenger car or truck, or a bus or motorcycle) is described that includes the control unit described in this document.

According to another aspect, a method for controlling a camera that is carried in a vehicle is described. The method comprises determining subject data relating to a subject to be captured. The subject to be captured may be located in front of the vehicle in the direction of travel. Alternatively or additionally, the subject can be positioned next to or behind the vehicle. If the subject is located next to or behind the vehicle, the vehicle can be decelerated (e.g. automatically), for example, in order to be able to take another photograph of the subject.

The method also comprises controlling the camera in accordance with the subject data in order to take a photograph of the subject using the camera. The subject data can be provided by a vehicle-external unit.

According to a further aspect, a software (SW) program is described. The SW program can be configured to be executed on a processor (e.g. on a control unit of a vehicle), and thereby to execute the method described in this document.

According to a further aspect, a storage medium is described. The storage medium can comprise a SW program which is designed to be executed on a processor and thereby to execute the method described in this document.

It is important to note that the methods, devices and systems described in this document can be used both alone and in combination with other methods, devices and systems described in this document. In addition, all aspects of the methods, devices and systems described in this document can be combined with one another in a wide variety of ways. In particular, the features of the claims can be combined with one another in a variety of ways.

### BRIEF DESCRIPTION OF THE DRAWINGS

FIG. 1 shows exemplary components of a vehicle;

FIG. 2 shows an exemplary driving situation with a subject to be captured; and

FIG. 3 shows an exemplary method for controlling a camera in a vehicle.

### DETAILED DESCRIPTION OF THE DRAWINGS

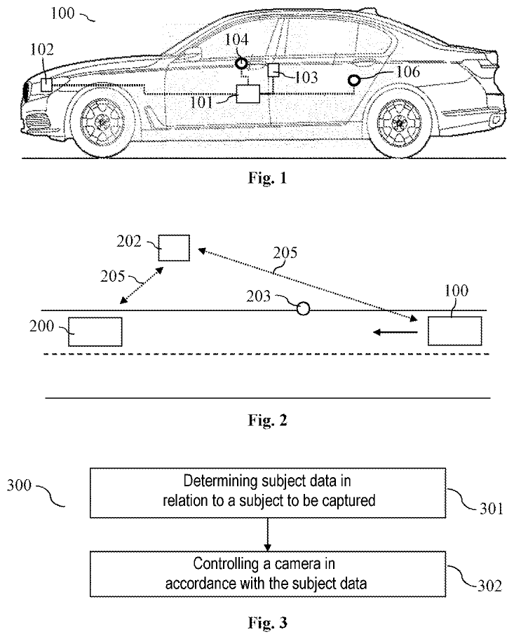

As explained at the beginning, this document is concerned with increasing the quality of photographs taken with a camera in a vehicle. In this context, FIG. 1 shows exemplary components of a vehicle 100. The vehicle 100 can comprise one or more environment sensors 102 (e.g., an environment camera, a radar sensor, a lidar sensor, etc.) that are configured to acquire sensor data (also referred to in this document as environment data) in relation to the environment of the vehicle 100. In addition, the vehicle 100 can comprise a position sensor 103, which is configured to acquire sensor data (also referred to in this document as position data) in relation to the position of the vehicle 100. In addition, the vehicle 100 can comprise a communication unit 106 which is configured to exchange communication data with a vehicle-external unit (e.g. with an infrastructure unit of the road network on which the vehicle 100 is being driven and/or with another road user) via a (wireless) communication link.

In addition, at least one camera 104 is arranged in the vehicle 100, which is designed to capture photographs relating to the environment of the vehicle 100. For example, the camera 104 can be held by an occupant of the vehicle 100. Alternatively, the camera 104 can be mounted on a bracket in the vehicle 100 (not shown).

A control unit 101 of the vehicle 100 can be configured to determine subject data relating to a subject in the environment of the vehicle 100 that is to be captured with the camera 104, based on the environment data, based on the position data (e.g. in combination with a digital map relating to the road network being used by the vehicle 100), and/or based on received communication data. In particular, the subject data can indicate or comprise the direction and/or orientation and/or position of the camera 104 for capturing the subject; and/or the shutter release time and/or the shutter release position at which the camera 104 must be triggered in order to capture the subject.

The control unit 101 can also be configured to control the camera 104 in accordance with the subject data (e.g. by sending a control instruction to the camera 104 via a wireless or wired communication link) in order to take a photograph of the subject.

Alternatively or additionally, the control unit 101 can be configured to control an action of the user of the camera 104 based on the subject data. For example, a voice output, a haptic signal, and/or an optical signal can be used to prompt the user to hold the camera 104 as specified by the subject data for taking the photograph (in particular at the position and/or orientation indicated by the subject data).

FIG. 2 shows an example driving situation in which the vehicle 100 is following another road user 200 (e.g. a vehicle driving in front) on a road (indicated by the arrow). The user of the vehicle 100 may have informed the control unit 101 of the vehicle 100 via a user interface that the camera 104 should be used to take a photograph of a specific subject 203 (e.g. of a specific point of interest) while driving the vehicle 100, wherein the subject 203 may be in front of the vehicle 100 in the direction of travel of the vehicle 100. Alternatively or additionally, the subject 203 can be arranged next to or behind the vehicle 100.

The control unit 101 can use the communication unit 106 and/or a (wireless) communication link 205 to instruct a vehicle-external unit 200, 202, e.g. the road user 200 driving in front and/or an infrastructure unit 202, to provide subject data relating to the subject 203 to be captured. For example, the vehicle-external unit 200, 202 can be instructed to determine the exact position of the subject 203 to be captured and to send it to the control unit 101 as subject data. The camera 104 in the vehicle 100 can then be operated precisely and reliably on the basis of the received and/or determined subject data in order to take a high-quality photograph of the subject 203 (and, if appropriate, of the user).

The subject data can be communicated to a server by another road user 200, wherein the server is designed to store the subject data for a plurality of different subjects 203. The control unit 101 can then download the subject data for a selection of one or more subjects 203 from the server if required. The control unit 101 can be configured to convert the subject data for a subject 203 provided in a general form to the specific situation of the vehicle 100 (in particular with regard to the exact shutter release time and/or the exact shutter release position and/or with regard to the orientation of the camera 104).

Thus, a database of subject data for subjects 203 of interest can be provided. This further increases the convenience for users of cameras 104.

A system is thus described for the optimal or optimized and automatic triggering of a hand-held or on-board camera 104 installed in a moving vehicle 100 for photographing a specific subject 203. The subject 203 should be photographed in an optimized way (e.g. without an interfering obstacle and/or with correct light conditions (in particular not towards the sun)) at the current driving speed of the vehicle 100.

For this purpose, an automatic pre-calculation of the earliest possible or the exact time of triggering the camera 104 can be performed. The trigger for releasing the shutter of the camera 104 can be received e.g. (as subject data) by Car-to-Car or Car-to-X communication. Using Car-to-X communication, a fixed coordinate with respect to the subject 203 in a high-resolution digital map can be sent to the camera 104 via the vehicle 100, via the infrastructure 202, via an app, and/or “over the air”. The camera 104 and/or the control unit 101 of the vehicle 100 can have access to the digital map.

A Car-to-Car message can be used to receive a signal (i.e. subject data) from a vehicle 200 in front. The vehicle 200 in front can be designed to determine the position of the subject 203 using one or more environment sensors. In particular, the optimum shutter release position and/or the optimum shutter release time can be determined by the vehicle 200 traveling in front. Current weather conditions and/or light conditions can be taken into account. The information relating to the shutter release time and/or the shutter release position can then be sent as subject data to the control unit 101 of the following vehicle 100 and/or directly to the camera 104.

If necessary, multiple different sources of information (e.g. a vehicle 200 traveling in front and/or an infrastructure unit 202) can be combined in order to determine the shutter release point and/or shutter release position particularly accurately. The camera 104 can then be triggered at the determined shutter release position or at the determined shutter release time in order to take an optimized photograph of the subject 203. It may be advantageous for taking the photograph that the vehicle 100 in which the camera 104 is located adjusts its traffic lane, the trajectory within the lane, its speed relative to the traffic situation and/or a given speed limit to further improve the quality of the photograph. This can be indicated as part of the determined subject data and taken into account by the control unit 101. In particular, the driver of the vehicle 100 (e.g. by issuing an instruction) can be prompted to change the driving state of the vehicle 100 for taking the photograph.

In the context of the described system or method the following data and/or information can be used:
data relating to one or more vehicle components; e.g. tire pressure monitoring system or air pressure, tire wear and/or current friction values, engine power and torque on the axles, etc.;
GPS data (traffic), Car-to-Car (V2V) data and/or Car-to-X (V2X) data in order to query a queue of vehicles ahead, which may not be visible to the environment camera 102 of the vehicle 100 (e.g. when in a traffic queue);
map data and/or traffic lane geometry;
topography (gradient);
weather and/or climate;
braking power;
loading condition (weight, type of load); and/or

maximum longitudinal and/or lateral acceleration forces.

FIG. 3 shows a flowchart of an exemplary (possibly computer-implemented) method 300 for controlling a camera 104 (e.g. a compact camera or an SLR camera) that is carried in a (motor) vehicle 100 (by a user or occupant). For example, the camera 104 can be held by an occupant of the vehicle 100. Alternatively or additionally, the camera 104 can be mounted on a bracket in the vehicle 100.

The method 300 comprises determining 301 subject data in relation to a subject 203 to be captured, which may be travelling in front in the direction of travel of the vehicle 100. The subject data can be provided by a vehicle-external unit 200, 202 (in particular sent to the camera 104 and/or the vehicle 100 and/or received from the camera 104 and/or the vehicle 100 via a wireless communication link 205).

The method 300 also comprises controlling 302 the camera 104 in accordance with the subject data, in order to take a photograph of the subject 203 using the camera 104. In particular, in accordance with the subject data (e.g. in accordance with a shutter release time or a shutter position indicated in the subject data), the shutter of the camera 104 can be automatically activated to take a photograph of the subject 203.

The measures described in this document enable an occupant of a vehicle 100 to take optimized photographs with a camera 104, even when the vehicle 100 is moving. This can increase the convenience and satisfaction of the occupant.

The present invention is not limited to the exemplary embodiments shown. In particular, it is important to note that the description and the figures are intended only as examples to illustrate the principle of the proposed methods, devices and systems.

1-11. (canceled)

12. A system, comprising:
a camera of a vehicle; and
a control unit configured to: determine subject data in relation to a subject, and control the camera in accordance with the subject data so as to capture an image of the subject using the camera.

13. The system of claim 12, wherein the subject data indicate a shutter release time and/or a shutter release position at which the camera is to be triggered in order to capture the image of the subject.

14. The system of claim 12, wherein the control unit is configured to receive the subject data from another road user, which is arranged in front of the vehicle in the direction of travel of the vehicle.

15. The system of claim 12, wherein the control unit is configured to receive the subject data from an infrastructure unit of a road network on which the vehicle is driven.

16. The system of claim 12,
wherein the subject data indicate how the vehicle should move to allow the image of the subject to be captured, with respect to one or more of: a traffic lane in which the vehicle should be located, a vehicle speed of the vehicle, a trajectory of the vehicle, and an orientation of the vehicle relative to the subject; and
wherein the control unit is configured to cause the vehicle to move as indicated by the subject data.

17. The system of claim 16, wherein the control unit is configured to:
issue an instruction to a driver of the vehicle to cause the vehicle to move as indicated by the subject data; and/or
intervene automatically in the longitudinal and/or lateral guidance of the vehicle in order to cause the vehicle to move as indicated by the subject data.

18. The system of claim 12, wherein the control unit is configured to:
determine position data relating to a position of the vehicle, and
control the camera also in accordance with the position data, including a digital map relating to the road network on which the vehicle is driving, in order to take the photograph of the subject using the camera.

19. The system of claim 12, wherein the control unit is configured to:
determine vehicle data relating to a condition of the vehicle, wherein the vehicle data includes one or more of: information relating to a tire pressure of at least one tire of the vehicle, information relating to the wear condition of one of the tires of the vehicle, information relating to a loading condition of the vehicle, and information relating to a vehicle speed of the vehicle; and
control the camera in accordance with the vehicle data in order to capture the image of the subject using the camera.

20. The system of claim 12, wherein the control unit is configured to:
determine environmental data relating to the environment of a vehicle, wherein the environmental data was acquired in particular by one or more environment sensors of the vehicle; and
determine the subject data on the basis of the environmental data.

21. The system of claim 12, wherein the control unit is configured to:
send a request for the provision of subject data for the subject to a vehicle-external unit; and
receive the subject data from the vehicle-external unit in response to the request.

22. A method for controlling a camera of a vehicle, the method comprising:
determining subject data in relation to a subject; and
controlling the camera in accordance with the subject data to capture an image of the subject using the camera.
